(19) United States
(12) Patent Application Publication
(10) Pub. No.: US 2012/0167834 A1
(43) Pub. Date: Jul. 5, 2012

(54) Storage Compartment Leash

(76) Inventors: Michael Cummings, Manitowoc, WI (US); Megan Cummings, Manitowoc, WI (US)

(21) Appl. No.: 12/984,873

(22) Filed: Jan. 5, 2011

(51) Int. Cl. A01K 27/00

(52) U.S. Cl. 119/796

(57) ABSTRACT

A storage compartment leash comprising a leash, where the leash includes one of a standard leash and a retractable leash; a handle attached to an end of the leash; a pocket affixed to the leash near the handle, where the pocket holds a plurality of items; an attachment means to connect the pocket to the leash, where the attachment means enables the pocket to be removably attached to the leash; and a closure attached to an opening in the pocket, wherein the closure ensures that the plurality of items do not fall out of the pocket. The pocket attaches to either a standard leash or a retractable leash and is interchangeable between both.

### BACKGROUND OF THE INVENTION

1. Field of the Invention

The present invention relates to a leash that includes a storage compartment to enable a user to store and carry their belongings while using either a standard leash or a retractable leash.

2. Description of Related Art

Pet owners understand the importance of walking their pets and normally utilize leashes attached to the pet's collar or a harness. Either a standard leash or a retractable leash is used depending on the likes and preferences of the owner. A problem with the leashes available is that when the owner and the pet set out for a walk storage space for personal items is limited. The owner is often left trying to juggle their various items, trying to fit them into their pockets or a separate storage bags (i.e., a purse, tote, or backpack) that they carry with them.

Some advances have been made to create a storage compartment where a person can place their belonging on or within the leash while on a walk. For example, U.S. Pat. No. 5,718,192 by Arlin Sebastian discloses a leash and attached carrying bag wherein the leash has a purse-like bag attached with Velcro® by the handle to hold empty and used waste bags. The bag includes a fold over flap as a closure.

Alternatively, a few retractable leashes include storage feature for convenience to the owner. First, U.S. Pat. No. 5,890,456 by Bruce D. Tancrede discloses a retractable animal leash device wherein the housing includes a storage compartment to hold animal waste bags. The opening of the storage compartment includes a hinged door that extended from the housing to receive the waste bags into the inner cavity of the housing. Finally, U.S. Pat. No. 6,314,917 by Timothy Ryan discloses a retractable leash pack wherein a compartmentalized pack with either a mesh compartment or a zipper close compartment or both are configured to fit around a retractable leash. While all of these leashes do provide the desired storage receptacles they each are only designed to be compatible with either the standard leash or a retractable leash but not both.

It would be desirable in the art to provide a pet leash that enables a user to carry their belongings within a storage space included with the leash. It would also be beneficial for the storage compartment to interchange between a standard leash and a retractable leash.

### SUMMARY OF THE INVENTION

An object of the present invention is to provide a leash with a storage pocket to enable a user to store and carry their small personal belongings while walking or running with their pets.

Another object of the present invention is to provide a leash with a storage pocket that is interchangeable between a standard pet leash and a retractable leash. In view of the foregoing disadvantages inherent in the prior art, the purpose of the present disclosure is to provide a storage compartment leash comprising a leash, where the leash is one of a standard leash and a retractable leash; a handle attached to an end of the leash; a pocket affixed to the leash near the handle, where the pocket holds a plurality of items; an attachment means to connect the pocket to the leash, where the attachment means enables the pocket to be removably attached to the leash; and a closure attached to an opening in the pocket, wherein the closure ensures that the plurality of items do not fall out of the pocket. The pocket attaches to either a standard leash or a retractable leash and is interchangeable between both.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawings, wherein like elements are identified with like symbols, and in which:

FIG. 1 depicts a perspective view of a storage compartment leash in accordance with an exemplary embodiment of the present invention; and

FIG. 2 depicts a perspective view of a storage compartment leash in accordance with an alternative embodiment of the present invention.

Like reference numerals refer to like parts throughout the description of several views of the drawings.

### DETAILED DESCRIPTION OF THE DRAWINGS

The present invention relates to a leash that includes a storage compartment to enable a user to store and carry their belongings while using the leash. The present invention provides a storage compartment leash that comprises a leash with a removable pocket to hold the user's various items. The storage compartment leash may enable the removable pocket to attach to either a standard leash or a retractable leash and interchange between the two. The leash and pocket may be available in a range of lengths and in a variety of colors, patterns and designs. The storage compartment leash may be ideal for users who walk or run and need a place to store their water, treats, plastic waste bags, keys, cell phone or similar items.

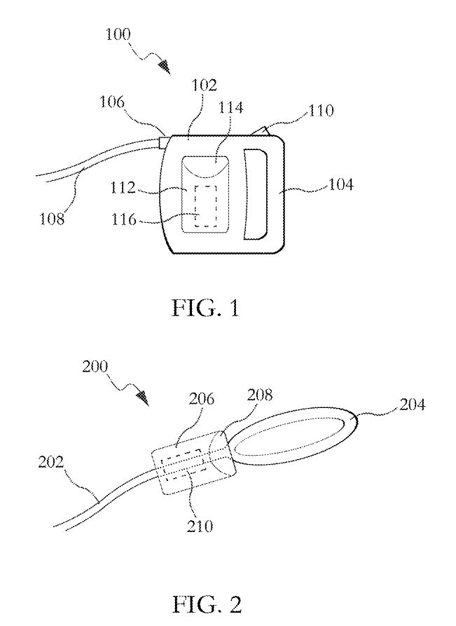

Tuning now descriptively to the drawings, referring to FIG. 1, a perspective view of a storage compartment leash (100) is shown in accordance with an exemplary embodiment of the present invention. The storage compartment leash (100) is essentially a retractable leash which includes a housing (102) to contain and carry the various components. The housing (102) includes a handle (104) positioned to either a backside of the housing (102) or a topside of the housing (102). The handle (104) enables a user to grip and control the storage compartment leash (100). On a front portion of the housing (102) is a slot (106) that enables a cord (108) to extend and retract from the housing (102). The cord (108) is wrapped around a coil within the housing (102) to allow the cord (108) to automatically retract after extension. Positioned near the handle (104) is a tension button (110). The tension button (110) stops or slows the cord (108) from extending or retracting to control the length of cord (108) that comes from the housing (102). Additionally, the tension button (110) may have a locking feature to lock the leash at a specific distance.

Fastened to a side face of the housing (102) is a pocket (112). The pocket (112) provides a compartment on the housing (102) for the user to store items including treats, keys, a phone, a watch, money, waste bags or a plurality of other small items. The pocket (112) may be made from a durable nylon fabric, leather, canvas or the like. Within the pocket (112) may be a divider to separate the inner portion of the pocket (112) into multiple compartments. The multiple compartments allow the user to separate items like the treats and money or the phone and keys.

Attached to a top portion of the pocket (112), where the pocket (112) opens, is a closure (114). The closure (114) closes the pocket (112) to ensure that the inner contents do not fall out of the pocket (112). The closure (114) may be a flap or a zipper. The closure (114) may include a securing means to join the closure (114) against the pocket (112). The securing means may be a hook and loop fastener, a snap or a magnet for easy opening of the closure (114).

Fastened to a backside of the pocket (112), between the pocket (112) and the housing is an attachment means. The attachment means (116) may be a hook and loop fastener or a snap that allows the pocket (112) to be removably attached to the housing (102). The removable pocket (112) is useful in case the user wishes to use the pocket (112) as a wallet to store their personal items without carrying the storage compartment leash (100).

Referring now to FIG. 2 a perspective view of a storage compartment leash (200) is shown in accordance with an alternative embodiment of the present invention. The storage compartment leash (200) includes a leash (202) paired with a handle (204) to comprise a standard dog leash. The leash (202) may be leather, nylon or other commonly used materials in the art. Attached to a portion of the leash (202) closest to the handle (204) may be a pocket (206). The pocket (206) includes a closure (208) to close and open an opening in the pocket (206). Behind the pocket (206) is an attachment means (210) that secures the pocket (206) to the leash (202). The attachment means (210) may be a hook and loop fastener, a snap or a portion of fabric. The portion of fabric enables the leash (202) to slide between the pocket (206) and the portion of fabric which essentially threads the leash (202) behind the pocket (206) for adjustable placement.

The storage compartment leash allows the user to store and carry their personal items in the pocket for convenient transport. By providing a pocket, the storage compartment leash lets the user only carry the leash and no other purses, bags or wallets while walking their pet. This frees up the user's hands so that they may focus on their pet rather than how to juggle the various items they must carry. Finally, the pocket may be interchanged between the standard leash or the retractable leash so that the user has the choice between one or the other.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A storage compartment leash comprising:
a leash, where said leash is one of a standard leash or a retractable leash;
a handle attached to an end of said leash;
a pocket affixed to said leash near said handle, where said pocket holds a plurality of items;
an attachment means to connect said pocket to said leash, where said attachment means enables said pocket to be removably attached to said leash; and
a closure attached to an opening in said pocket, wherein said closure ensures that said plurality of items do not fall out of said pocket, and wherein said attachment means enables said pocket to interchange between said standard leash and said retractable leash.

2. The storage compartment leash according to claim 1, wherein said closure is a flap.

3. The storage compartment leash according to claim 3, wherein said flap attaches to said pocket with a securing means.

4. The storage compartment leash according to claim 4, wherein said securing means is one of at least a hook and loop fastener, a snap and a magnet.

5. The storage compartment leash according to claim 1, wherein said attachment means is one of at least a hook and loop fastener and a snap.

6. The storage compartment leash according to claim 1, wherein said pocket includes a divider to separate an inner portion of said pocket into multiple compartments.
